(19) United States
(12) Patent Application Publication
(10) Pub. No.: US 2008/0010366 A1
(43) Pub. Date: Jan. 10, 2008

(54) System and method for generating unique and persistent identifiers

(76) Inventor: Matthew Edward Duggan, Surrey (GB)

Correspondence Address: Brown Raysman Millstein Felder & Steiner LLP, 900 Third Avenue, New York, NY, 10022, US

(21) Appl. No.: 11/444,887

(22) Filed: May 31, 2006

Related U.S. Application Data
(60) Provisional application No. 60/686,227, filed on May 31, 2005.

(51) Int. Cl. G06F 15/173

(52) U.S. Cl. 709/223; 709/224

(57) ABSTRACT

The present invention relates to systems and methods for generating unique and persistent identifiers for one or more entities within a network. The method of the present invention comprises discovering one or more entities within a network, a given entity associated with one or more attributes and an entity type. One or more unique and persistent identifier generation rule sets comprising one or more unique and persistent identifier generation rules are retrieved, wherein the rule sets correspond to the one or more entity types discovered within the network. Unique and persistent identifiers are generated for the one or more discovered entities within the network through use of the unique and persistent identifier generation rule sets and the one or more attributes associated with the one or more entities.

This application claims priority to U.S. provisional application No. 60/686,227, entitled “SYSTEM AND METHOD FOR UNIQUE AND PERSISTENT IDENTIFIERS,” filed May 31, 2005, the disclosure of which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to systems and methods for generating unique and persistent identifiers. More specifically, the present invention relates to the generation of unique and persistent identifiers for one or more entities within a given network.

### BACKGROUND OF THE INVENTION

Networks are commonly employed to facilitate the transfer of various types of data among a plurality of devices. The identification of individual network devices in a given network is often necessary to identify errors or faults within a given network, determine the root cause of errors or faults, generate a model of a network, etc. Current systems for the discovery and rediscovery of devices communicatively coupled to a communications network are capable of identifying such devices. The identifiers generated by current systems, however, are generated utilizing information subject to modification or change that result in identifiers that are neither unique nor persistent.

Owners and operators of networks may utilize various products and services to ascertain computing devices in a given network. For example, a network operator may utilize a network discovery system to collect data identifying the devices within a given network and to model and map device-to-device network relationships. Similarly, a network discovery system may be utilized to ascertain underutilized devices within a network or to identify one or more faults within the network.

The accurate identification of individual network devices, as well as the one or more constituent components of a given network device, are essential to the analysis of a given network. In order to identify a given network device, network discovery systems may generate a name or similar identifier for the one or more devices within a given network. The name or identifier assigned to the one or more devices within a given network may be used by various applications, such as network modeling applications, to identify and monitor the one or more devices in a given network.

Current techniques for naming entities or devices in a given a network may utilize IP addresses, system names, Domain Name Server (“DNS”) lookups, or arbitrarily generated integer identifiers, such as those generated by a relational database management system (“RDBMS”) automated sequence generator. The attributes utilized by existing techniques to generate identifiers for devices within a network, however, are frequently subject to modification or change. For example, a network discovery system may generate an identifier for a given computing device using the IP address of the respective device. Thereafter, a service provider may update or change the IP address of the computing device, unbeknownst to the network discovery system. Applications that utilize the identifier of a given computing device, such as a network modeling application, may display inaccurate information where identifiers are subject to change.

Additionally, current techniques are limited to identifying the one or more devices in a given network using only the attributes associated with a given device. The one or more devices in a network, however, may be associated with or related to one or more devices in the network, such as one or more constituent components, a parent device, a root device, etc. For example, a blade server in a network may comprise a chassis and a plurality of slots into which blade servers may be inserted to expand the functionality of the chassis. The attributes associated with the one or more slots may be periodically updated or changed (e.g., an IP address), whereas the attributes associated with the chassis may comprise attributes that are not subject to change (e.g., a serial number). Current methodologies, however, are limited to generating identifiers for the one or more slots using only the attributes associated with the slots, thus resulting in identifiers that may be subject to change.

In order to overcome shortcomings associated with existing techniques for generating identifiers for devices in a network, embodiments of the present invention provide systems and methods for generating identifiers that are unique and persistent.

### SUMMARY OF THE INVENTION

The present invention is directed towards systems and methods for generating unique and persistent identifiers for one or more entities within a network. The method of the present invention comprises discovering one or more entities within a network, wherein an entity is associated with one or more attributes and an entity type. According to one embodiment of the invention, the one or more entities discovered within a network are discovered through use of a network discovery application. An entity within a network may comprise a hardware device, a constituent component of a hardware device, or an application stored on a hardware device. The attributes associated with a given entity may comprise a serial number, a Media Access Control (“MAC”) address, a sysObjectID, a device model number, a Domain Name Server (“DNS”) name, or an Internet Protocol (“IP”) address.

One or more unique and persistent identifier generation rules sets corresponding to the one or more entity types discovered within the network are retrieved, wherein a rule set comprises one or more unique and persistent identifier generation rules. The one or more rules comprising a rule set identify one or more attributes with which an entity must be associated in order to generate a unique and persistent identifier according to the rule. The utilization of one or more attributes associated with a given entity to generate an identifier, as required by a given rule, increases the likelihood that the identifier generated for the respective entity is unique with respect to the one or more entities in a given network within a desired probability.

A given rule within a rule set further identifies the persistence of a given unique and persistent identifier generated according to the rule, wherein the persistence of a given unique and persistent identifier comprises the duration of time for which the unique and persistent identifier, generated according to a given rule, is to be considered valid. According to one embodiment, the persistence of a given unique and persistent identifier is based upon the one or more attributes associated with the rule used to generate the unique and persistent identifier. For example, a rule requiring a given entity to be associated with an attribute that is not subject to change, such as a “serial number” attribute, may generate a unique and persistent identifier with a greater persistence than a rule requiring a given entity to be associated with an attribute subject to frequent change, such as an “IP address” attribute.

The method of the present invention further comprises generating unique and persistent identifiers for the one or more discovered entities within the network through use of the unique and persistent identifier generation rules sets and the one or more attributes associated with the one or more entities. According to one embodiment of the invention, a unique and persistent identifier is generated using the unique and persistent identifiers of the one or more entities with which a given entity is related, wherein a related entity may comprise an immediate parent of a given entity or a root entity associated with a given entity. The unique and persistent identifiers generated may comprise identifiers in Message-Digest algorithm 5 (“MD5”) format or in a human-readable format.

The present invention is further directed towards a system for generating unique and persistent identifiers for one or more entities within a network. The system of the present invention comprises a discovery component operative to identify one or more entities within a network, wherein a given entity is associated with one or more attributes and an entity type. The discovery component is operative to identify one or more entities through use of a network discovery application. The discovery component is further operative to identify one or more entities with which a given entity is related. Additionally, the discovery component is operative to identify a serial number, device model number, sysObjectID, Media Access Control (“MAC”) address, and Internet Protocol (“IP”) address of a given entity.

The system of the present invention further comprises a rule data store operative to store one or more rule sets comprising one or more rules for generating unique and persistent identifiers for the one or more entities in the network. According to one embodiment, the one or more rules comprising a rule set identify one or more attributes with which a given entity must be associated in order to generate a unique and persistent identifier according to the one or more rules.

The one or rules comprising a rule set may also identify a time period for which one or more unique and persistent identifiers generated according to the one or more rules are to be considered valid. Additionally, the one or more rules comprising a rule set may be associated with priority information indicating an ordering with which the one or more rules are to be evaluated with respect to a given entity.

A UPI component is operative to retrieve a rule set comprising one or more rules corresponding to a given entity in the network and generate a unique and persistent identifier for the entity using the rule set retrieved and the one or more attributes associated with the entity. The UPI component may further perform one or more validation checks upon the one or more attributes associated with the entity. According to one embodiment, the UPI component is operative to generate a unique and persistent identifier for an entity using the one or more rules comprising a rule set according to the priority information associated with the one or more rules. Additionally, the UPI component is operative to generate a unique and persistent identifier for an entity indicating the rule with which the unique and persistent identifier was generated.

According to one embodiment, the UPI component generates unique and persistent identifiers using one or more unique and persistent identifiers of the one or more entities with which a given entity is related. The one or more entities with which a given entity is related may comprise an immediate parent of a given entity or a root entity associated with a given entity.

### BRIEF DESCRIPTION OF THE DRAWINGS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

FIG. 1 is a block diagram presenting a system for generating unique and persistent identifiers for one or more entities according to one embodiment of the present invention;

FIG. 2 is a block diagram presenting an entity with various constituent components for which unique and persistent identifiers may be generated according to one embodiment of the present invention;

FIG. 3 is a flow diagram presenting a method for generating unique and persistent identifiers for one or more entities according to one embodiment of the present invention;

FIG. 4 is a flow diagram presenting a method for generating unique and persistent identifiers using a rule set associated with a given entity type according to one embodiment of the present invention; and

FIG. 5 is a flow diagram presenting a method for generating a unique and persistent identifier using one or more unique and persistent identifiers of one or more entities associated with a given entity according to one embodiment of the present invention.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

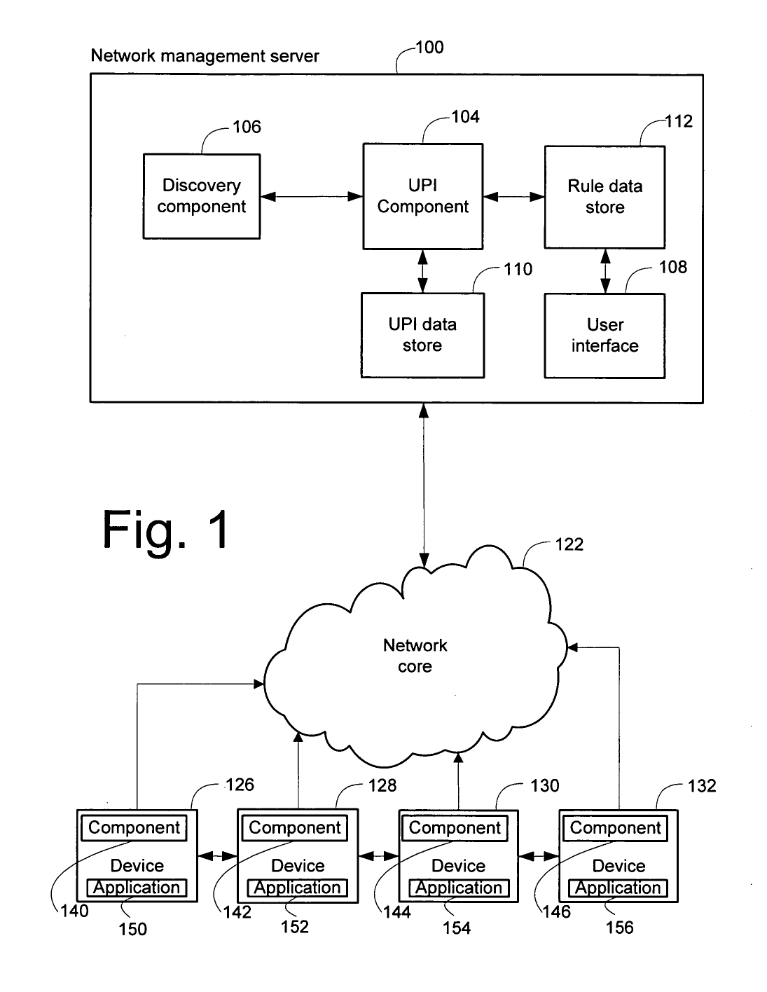

FIG. 1 is a block diagram illustrating a system for generating unique and persistent identifiers for one or entities within a network. According to the embodiment illustrated in FIG. 1, a network comprises a plurality of devices 126, 128, 130, and 132, which may include interconnections between the one or more devices 126, 128, 130, and 132. A device may comprise a hardware device including, but not limited to, a server, router, switch, or printer. A device may contain physical and logical components 140, 142, 144, and 146 including, but not limited to, a slot, card, port, power supply, fan, sensor, or interface. Additionally, a device may contain one or more processes, applications 150, 152, 154, and 156, or services.

A network, which may provide transport for a variety of types of data, e.g., voice, audio, video, etc., may comprise a high-speed network core 122 that provides transport for data from a variety of networks, e.g., local networks and wide area networks. According to the embodiment illustrated in FIG. 1, a network management server 100 is communicatively coupled to the network. As illustrated in FIG. 1, the management server 100 may be directly connected to the network core 122. Alternatively, or in conjunction with the foregoing, the management server 100 may be connected to one or more alternative or additional areas of a network. The network management server 100 provides for the discovery and rediscovery of devices 126, 128, 130, 132 comprising the network, as well as the one or more applications 150, 152, 154, and 156 or constituent components 140, 142, 144, and 146 maintained by a given device 126, 128, 130, and 132.

According to the embodiment illustrated in FIG. 1, the network management server 100 comprises a discovery component 106, a UPI component 104, a UPI data store 110, a rule data store 112, and a user interface 108. The discovery component 106 at the network management server 100 is operative to provide for the discovery and rediscovery of devices 126, 128, 130, and 132, and the one or more applications 150, 152, 154, and 156 and constituent components 140, 142, 144, and 146 maintained by a given device 126, 128, 130, and 132. For example, where a chassis contains a number of slots for accepting cards that comprise one or more communications interfaces, the discovery component 106 may identify the chassis, the one or more slots, and the relationship between cards and slots contained in the chassis. The devices discovered by the discovery component 106 may comprise one or more devices discoverable via one or more protocols, including but not limited to, the Telnet, Secure Shell (“SSH”), Simple Network Management Protocol (“SNMP”), serial communications, and Transaction Language 1 (“TL1”) protocols.

The discovery component 106 may identify the components 140, 142, 144, and 146 or applications 150, 152, 154, and 156 of a given device 126, 128, 130, and 132 through the use of a number of mechanisms. For example, the discovery component 106 may recursively query the interfaces on a given device 126, 128, 130, and 132 to determine the constituent components of a given device 126, 128, 130, and 132. Alternatively, or in conjunction with the foregoing, the discovery component 106 may retrieve an entity management information base (“MIB”) from a given device 126, 128, 130, and 132. The MIB may provide the discovery component 106 with information sufficient to model the given device 126, 128, 130, and 132 and its logical and physical characteristics, e.g., the MIB may identify a chassis that contains multiple applications 150, 152, 154, and 156, power supplies and sensors, which may in turn contain further entities or components 140, 142, 144, and 146.

The discovery component 106 is operative to retrieve one or more attributes of a given device 126, 128, 130, and 132, as well as attributes of the one or more components 140, 142, 144, and 146 or applications 150, 152, 154, and 156 of the device 126, 128, 130, and 132. Attributes associated with a given device 126, 128, 130, and 132 may comprise attributes including but not limited to, a serial number, a Media Access Control (“MAC”) address, an object identifier (e.g., sysObjectId), a device model number, an Internet Protocol (“IP”) address, or a Domain Name Server (“DNS”) name. The attributes retrieved by the discovery component 106 for a given device 126, 128, 130, and 132 and the one or more components 140, 142, 144, and 146 or applications 150, 152, 154, and 156 of the device 126, 128, 130, and 132 are delivered to the UPI (“Unique and Persistent Identifier”) component 104 at the network management server 100.

The UPI component 104 is operative to perform one or more validation checks on the one or more attributes of a given device 126, 128, 130, and 132, as well as the attributes of the one or more components 140, 142, 144, and 146 or applications 150, 152, 154, and 156 of the device 126, 128, 130, and 132. According to one embodiment of the invention, the validation check performed by the UPI component 104 comprises a POSIX (“Portable Operating System Interface”) expression match validation check upon the one or more attributes of a given device 126, 128, 130, and 132, component 140, 142, 144, and 146, or application 150, 152, 154, and 156. According to another embodiment of the invention, the validation check performed by the UPI component 104 comprises a database lookup to ensure that the one or more attributes of a given device 126, 128, 130, and 132, component 140, 142, 144, and 146, or application 150, 152, 154, and 156 are valid. Those of skill in the art recognize numerous techniques for performing validation checks upon one or more attributes of a given device 126, 128, 130, and 132, component 140, 142, 144, and 146, or application 150, 152, 154, and 156.

The UPI component 104 is further operative to generate a unique and persistent identifier (“UPI”) for a given device 126, 128, 130, and 132, as well as the one or more components 140, 142, 144, and 146 or applications 150, 152, 154, and 156 of the respective device. According to one embodiment of the invention, a UPI comprises a string that identifies an entity, wherein an entity may comprise a hardware device 126, 128, 130, and 132, a constituent component 140, 142, 144, and 146 of a hardware device 126, 128, 130, and 132, or an application 150, 152, 154, and 156 maintained by a hardware device 126, 128, 130, and 132. The UPI generated for a given entity may be in one or more formats, including but not limited to, a human readable string or a Message-Digest algorithm 5 (“MD5”) hashed representation of a human readable string.

A UPI is generated for a given entity using one or more UPI generation rules and the one or more attributes associated with the entity identified as valid by the UPI component 104. According to the embodiment illustrated in FIG. 1, the UPI component 104 is operative to retrieve one or more UPI generation rules from a rule data store 112. The rule data store 112 is operative to maintain one or more UPI generation rules and may comprise one or more accessible memory structures, such as a database, CD-ROM, tape, digital storage library, etc. The rule data store 112 may be implemented as a database or any other type of storage structure capable of providing for the retrieval and storage of one or more UPI generation rules.

A given rule maintained in the rule data store 112 identifies the one or more attributes that must be associated with a given entity in order to generate a UPI according to the given rule. For example, a given rule may identify that an entity must be associated with the attributes “serial number” and “sysObjectID” in order to generate a UPI according to the rule. Similarly, a rule may identify that an entity must have a “MAC address” attribute in order to generate a UPI according to the rule.

The one or more attributes required by the one or more rules in the rule data store 112 ensure that the UPIs generated by the one or more rules for the one or more entities in a given network are unique from one another within a desired probability. For example, a first rule may require an entity to be associated with a “serial number” attribute, whereas a second rule may require an entity to be associated with only a “device model number” attribute. A “serial number” attribute may comprise an attribute unique to a given entity, whereas a “device model number” attribute may comprise an attribute unique to an entity type, but common to the one or more entities comprising the entity type. Therefore, the UPIs generated using the rule requiring a “serial number” attribute are likely to be different from one another within a greater desired probability than the one or more UPIs generated using the rule requiring a “device model number” attribute.

The rule data store 112 is operative to maintain one or more rules in rule sets. According to one embodiment of the invention, a rule set comprises the one or more rules associated with a given entity type. For example, the rule data store 112 may maintain a rule set comprising one or more rules for a slot entity type. Similarly, the rule data store 112 may maintain a rule set comprising one or more rules for a port entity type or a card entity type. Those of skill in the art recognize the plurality of rule sets that may be maintained in the rule data store 112 for the one or more device types that may be discovered within a given network.

The rule data store 112 may be populated with one or more rule sets comprising one or more rules via a user interface 108 at the network management server 100. The user interface 108 allows one or more users, such as network administrators, to identify the one or more rules comprising a rule set for a given entity type. Additionally, a user may specify a priority or weight to be associated with the one or more rules comprising a rule set, wherein a priority identifies the order in which the one or more rules comprising a rule set are to be evaluated and used to generate a UPI with respect to a given entity. Specifying a priority or weight for one or more rules comprising a rule set allows a user to generate a UPI for a given entity using one or more attributes of the entity that the user deems more reliable, less prone to error, less likely to be subject to change, etc. Additionally, specifying a priority or weight for the one or more rules comprising a rule set allows a user to increase the likelihood that a UPI generated for a given entity is likely to be unique with respect to the one or ore entities in a given network.

According to one embodiment, the one or more attributes of the one or more entities in a given network may be considered to have a strength property, influencing the priority of a given UPI generation rule. For example, a given attribute, such as a “serial number” attribute may be identified as “strong,” whereas an “IP address” attribute may be identified as “weak.” The strength property of a given attribute may be based upon the uniqueness of the attribute as well as the duration of time for which the attribute is considered to be valid. The strength property of the one or more attributes associated with the one or more rules comprising a rule set may be used to determine the priority of the one or more rules.

For example, a user may wish to generate UPIs for one or more entities within a network. The user may deem the serial number attribute of a given entity to be the most reliable and unique attribute, e.g., the “strongest” attribute, and thus, may wish to generate UPIs for the one or more entities within the network using the “serial number” attribute of the one or more entities when available. The user may specify that in the absence of a “serial number” attribute, the “MAC address” attribute of a given entity be used for generating a UPI for the respective entity. Additionally, the user may specify that in the absence of both a “serial number” attribute and a “MAC address” attribute, the “sysObjectID” attribute of the entity be used for generating a UPI for the entity.

The abovementioned attribute priority may be used to generate one or more rules, wherein a given rule identifies the attributes that must be associated with a given entity in order to generate a UPI according to the rule. For example, with reference to the aforementioned attribute priority, the user may specify three rules, “Rule A,” “Rule B,” and “Rule C,” to be used for generating UPIs for a given entity type. “Rule A” may require an entity to be associated with the attribute “serial number,” which may be considered a “strong” attribute. “Rule B” may require an entity to be associated with the attribute “MAC address,” which may be considered a “relatively strong” attribute, and “Rule C” may require an entity to be associated with the attribute “sysObjectID,” which may be considered a “weak” attribute. The user may specify that Rule A is to be evaluated with respect to a given entity prior to Rule B, and Rule B is to be evaluated with respect to a given entity prior to Rule C, indicating the priority of the attributes with which a UPI is to be generated as selected by the respective user. Alternatively, or in conjunction with the foregoing, the user may specify that Rule A, Rule B, and Rule C are to be evaluated based upon the strength property of the attributes associated with each respective rule.

A given rule within a rule set may be further associated with a timestamp indicating the persistence of a given UPI generated according to the rule. According to one embodiment of the invention, the persistence of a given UPI comprises the duration of time for which the UPI, generated according to a given rule, is to be considered valid. For example, a rule may utilize an “IP address” attribute to generate a UPI for a given entity. Because of the potential volatility of an IP address, the rule may indicate that a UPI generated for an entity utilizing the rule may be considered valid for only a twenty-four (“24”) hour period. Similarly, a rule may utilize a “serial number” address to generate a UPI for a given entity. The rule may indicate that a UPI generated for an entity utilizing the rule may be considered valid for a period of one (“1”) year based upon the assumption that a serial number of a given entity is not subject to change. The indication of the persistence of a UPI generated according to a given rule may be used by various applications, such as network modeling applications or network discovery applications in order to determine when the rediscovery of entities within a given network may be necessary.

The UPI component 104 is operative to retrieve the rule set associated with a given entity type discovered by the discovery component 106 and generate a UPI for the entity using the one or more rules comprising the rule set. According to one embodiment, the UPI component 104 is operative to generate a UPI for a given entity indicating the rule with which the UPI was generated. For example, the one or more rules comprising a rule set may be associated with a name. The UPI component 104 may utilize the name of a given rule used to generate a UPI for a given entity to indicate the rule with which the UPI was generated.

According to one embodiment of the invention, the UPI component 104 is operative to generate a UPI for a given entity using one or more UPIs of one or more entities associated with the given entity. An entity associated with a given entity may include but is not limited to, an immediate parent entity of a given entity or a root entity associated with a given entity. For example, a given entity may comprise a port entity. The port entity may be contained within a card entity, comprising the immediate parent entity of the port entity. The card entity may be contained in a slot entity, which may be further contained in a chassis entity, comprising the root entity of the port entity. The UPI component 104 is operative to generate a UPI for the port entity using the UPI of the immediate parent entity of the port entity, e.g., the card entity, as well as the UPI of the root entity associated with the port entity, e.g., the chassis entity. The UPI associated with a parent entity and/or a root entity of a given entity may be used so as to reinforce entities that may be associated with attributes that are “weak,” unreliable, volatile, etc.

The UPIs generated by the UPI component 104 for the one or more entities discovered by the discovery component 106 may be maintained in a UPI data store 110. The UPI data store 110 is operative to maintain one or more UPIs generated by the UPI component for one or more entities discovered by the discovery component 106. The UPI data store 110 may comprise a database or similar structure capable of providing for the storage and retrieval of one or more UPIs.

Those of skill in the art recognize that the system illustrated in FIG. 1 is operative to identify and retrieve one or more attributes associated with a given entity and is not limited to the one or more attributes described above. Additionally, the system illustrated in FIG. 1 is operative to generate UPIs for one or more entities in a given network using a diverse set of attributes and is not limited to the one or more exemplary attributes described herein.

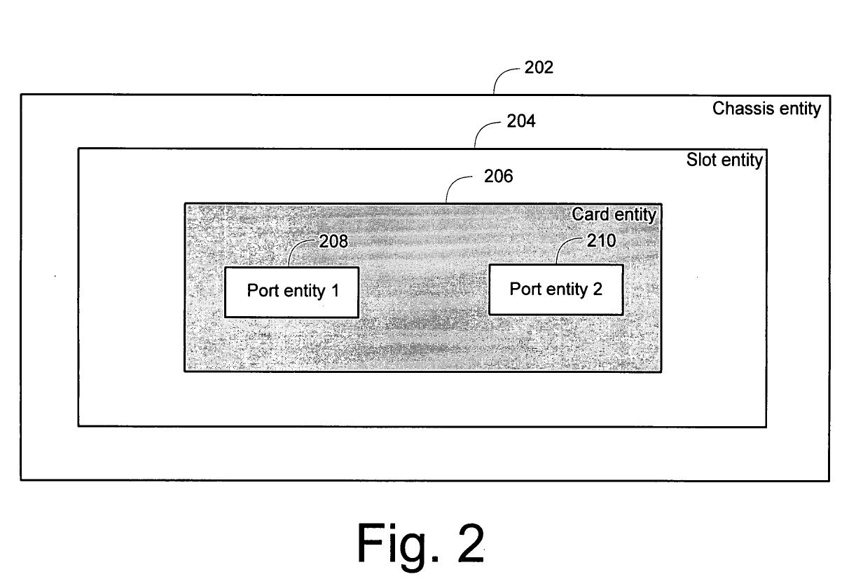

FIG. 2 is a block diagram illustrating one embodiment of a device for which one or more UPIs may be generated according to methods described herein. The device illustrated in FIG. 2 comprises a chassis entity 202 with a constituent slot entity 206. The slot entity 206 contains a card entity 206, which contains two port entities 208 and 210.

A UPI may be generated for the chassis entity 202 using one or more rules comprising a rule set associated with a chassis entity. The one or more rules comprising a rule set for a chassis entity may indicate the one or more attributes with which a chassis must be associated in order to satisfy the one or more rules. For example, a first rule in a rule set for a chassis entity may indicate that a chassis must be associated with a “serial number” attribute and a “device model number” attribute in order to generate a UPI according to the rule. Similarly, a second rule in a rule set for a chassis entity may indicate that a chassis must be associated with a “MAC address” attribute in order to generate a UPI according to the rule.

Additionally, the one or more rules in a rule set may be associated with timestamp information indicating the period of time for which a given UPI generated according to a given rule is to be considered valid. For example, a rule for generating a UPI using an “IP address” attribute of a given entity may be associated with timestamp information indicating that the UPI generated according to the rule is to be considered valid for a twenty four (“24”) hour period. Similarly, a rule for generating a UPI using a “serial number” attribute and a “device module number” attribute of a given entity may be associated with timestamp information indicating that the UPI generated according to the rule is to be considered valid for a two (“2”) year period of time.

A UPI may be generated for the chassis entity 202 illustrated in FIG. 2. The UPI generated for the chassis entity 202 may be in one or more formats, such as a character string in human-readable form or a character string in Message-Digest algorithm 5 format. The UPI generated for the chassis entity 202 may indicate the rule with which the UPI was generated and the duration of time for which the UPI is to be considered valid. For example, the MD5 format UPI “09fcd95c052a7da5462ea4ba06a7f4fb” may be generated for the chassis 202 entity using a rule from a chassis entity rule set requiring a “serial number” attribute. The UPI may indicate the rule that was used to generate the UPI, the rule set to which the rule belongs, and the period of time for which the UPI is to be considered valid.

UPIs may also be generated for the slot entity 204, the card entity 206, and the port entities 208 and 210 with the rule sets corresponding to each respective entity. As previously described, the UPIs generated for the entities illustrated in FIG. 2 may be generated using a UPI of the immediate parent entity associated with a given entity and/or the root entity associated with a given entity. For example, the port entity 1 208 may be associated with attributes that are considered “weak,” unreliable, volatile, etc. Therefore, a UPI may be generated for the port entity 1 208 using the UPI of the root entity with which the port entity 1 208 is associated, e.g., the chassis entity 202. Alternatively, or in conjunction with the foregoing, the UPI of the immediate parent entity associated with port entity 1 208, e.g., the card entity 206, may be used to generate a UPI for port entity 1 208. Similarly, the one or more attributes associated with the card entity 206 may be considered “weak.” A UPI may thus be generated for the card entity 206 using the UPI of the root entity with which the card entity 206 is associated, e.g., the chassis entity 202, and/or the UPI of the immediate parent entity associated with the card entity, e.g., the slot entity 204.

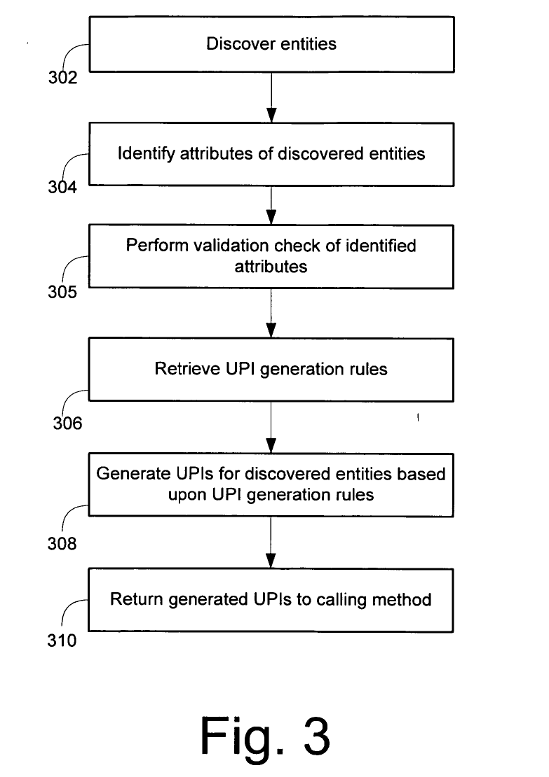

FIG. 3 is a flow diagram presenting a method for generating UPIs for one or more entities in a given network. According to the embodiment illustrated in FIG. 3, the one or more entities in a given network are discovered, step 302. The entities in a network may be discovered using one or more network discovery applications, such as the Netcool®/Precision™ for IP Networks product available from Micromuse Inc. (a subsidiary of International Business Machines Corporation). The one or more entities within a network may comprise one or more hardware devices, as well as the one or more constituent components of a given hardware device. Additionally, an entity may further comprise an application or process maintained by a given hardware device. Those of skill in the art recognize the various entities that may comprise a network and that may be discovered through the use of a network discovery application.

The attributes of the one or more entities discovered within the network are identified, step 304. The attributes of a given entity may be retrieved and identified by the network discovery application with which the one or more entities were discovered. The one or more attributes of a given entity may comprise information including, but not limited to the, the serial number, MAC address, device model number, or sysObjectID associated with the given entity. Additionally, the attributes of a given entity may comprise information such as the IP address or DNS associated with the entity.

A validation check is performed on the one or more attributes associated with the one or more entities discovered within the network, step 305. The validation check performed on the one or more attributes may comprise a POSIX expression match upon the one or more attributes of a given entity. Alternatively, or in conjunction with the foregoing, the validation check may comprise a database lookup to ensure that the one or more attributes associated with the one or more entities discovered within the network are valid. The one or more attributes associated with the one or more entities discovered within the network that are identified as invalid may be removed or otherwise discarded.

UPI generation rules corresponding to the one or more discovered entities are retrieved, step 306. The UPI generation rules for a given entity may comprise a set of one or more rules that correspond to a particular entity type. A network administrator or similar user may generate the one or more rules comprising a rule set corresponding to a particular entity type. For example, a network administrator may generate a set of rules corresponding to a printer entity type that may be retrieved for a printer discovered within a given network. Similarly, a network administrator may generate a set of rules corresponding to a router entity, which may be retrieved for a router discovered within a given network.

The UPI generation rules retrieved are used to generate UPIs for the one or more discovered entities in the network, step 308. According to one embodiment of the invention, a given rule within a rule set identifies the one or more attributes with which a given entity must be associated in order to generate a UPI according to the rule. For example, a first rule within a rule set corresponding to a port entity may identify that a port entity must be associated with a “serial number” and “MAC address” attribute in order to generate a UPI according to the rule. Similarly, a second rule within the rule set may identify that a port entity must be associated with a “sysObjectID” attribute in order to generate a UPI according to the rule.

The one or more rules within a rule set may be further associated with a priority with which the rules are to be evaluated with respect to a given entity. For example, a given rule set corresponding to a chassis entity may comprise three (“3”) rules. Associated with each of the three rules may be an indication of the order in which the rules are to be evaluated with respect to a chassis entity. The order with which the rules are to be evaluated may be based upon the attributes associated with each respective rule.

For example, a network administrator may generate a rule set comprising two rules for generating UPIs for routers within a network. The first rule within the rule set for generating UPIs for routers may require a router to have a “serial number” attribute and “MAC address” attribute, and the second rule may require a router to have a “sysObjectID” attribute. The network administrator may prefer UPIs that are generated using the “serial number” and “MAC address” attributes of a given router to UPIs that are generated using only the “sysObjectID” attribute of a given router. The network administrator may specify that the rule requiring a router to be associated with a “serial number” and “MAC address” attribute be evaluated and used to generate a UPI for a router discovered in a network prior to the rule requiring a router to be associated with only a “sysObjectID” attribute.

The one or more rules within a rule set may be further associated with timestamp information indicating the duration of time for which the UPIs generated according to the one or more rules are to be considered valid. Additionally, the one or more rules within a rule set may be associated with a name identifying the one or more rules. The UPIs generated for the one or more entities discovered within the network may indicate the rule with which the one or more UPIs were generated using the name of the one or more rules. Additionally, the UPIs generated for the one or more entities within the network may indicate the time span for which the one or more UPIs are to be considered valid using the timestamp information associated with the one or more rules used to generate the one or more UPIs.

The UPIs generated for the one or more entities in the network may be generated using the UPIs associated with the one or more entities identified as related to a given entity. According to one embodiment of the invention, a related entity comprises the immediate parent entity of a given entity. Alternatively, or in conjunction with the foregoing, a related entity comprises a root entity associated with a given entity. For example, a given entity may comprise a card entity. The card entity may be contained within a slot entity, which may be contained within a chassis entity. The UPI generated for the card entity may be generated using the immediate parent entity of the card entity, e.g., the slot entity, and/or the root entity associated with the card entity, e.g., the chassis entity. The UPI of a parent entity or a root entity may be utilized to generate a UPI for a given entity in order to ensure that the UPI generated for the entity is unique.

A given UPI may be in one or more formats, such as a human readable character string or a character string encoded according to a cryptographic hash function. The UPIs generated for the one or more entities discovered within the network may be returned to a calling method, step 310, wherein a calling method may comprise a network modeling application used to construct a visual representation of a given network.

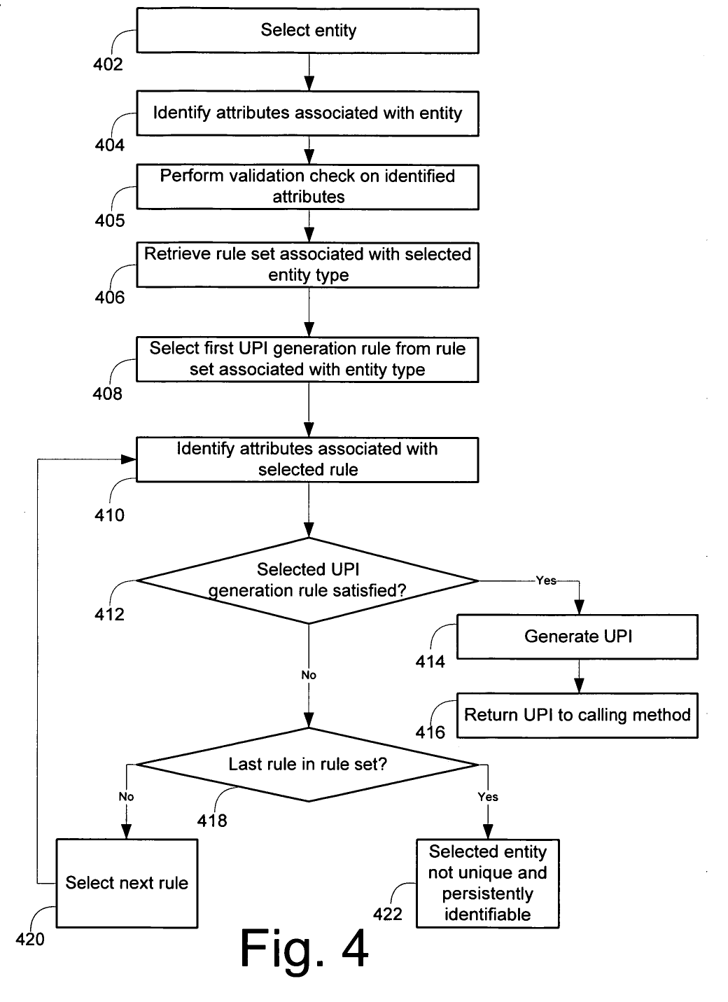

FIG. 4 is a flow diagram presenting a method for generating a UPI for a given entity using a rule set associated with the respective entity type. According to the embodiment illustrated in FIG. 4, a first entity is selected, step 402. An entity may comprise a hardware device, such as a router, switch, server, printer, etc. An entity may further comprise the physical or logical components of a given hardware device, such as a slot, card, port, fan, sensor, etc., as well as an application, process, or service that runs on a given hardware device.

The attributes of the selected entity are identified, step 404, wherein an attribute associated with a given entity may comprise an item of data identifying the entity. For example, the attributes associated with a router entity may include, but are not limited to, the MAC address and the IP address associated with the router. Similarly, an attribute associated with a component of the router, such as a fan or a sensor, may comprise the serial number of the respective component.

One or more validation checks are performed upon the one or more attributes of the selected entity, step 405. For example, a validation check may be performed to ensure that the one or more attributes associated with the selected entity are in a valid format. Similarly, a POSIX expression match validation check or a database lookup may be performed to ensure that the one or more attributes associated with the selected entity are valid. The one or more attributes identified as invalid may be discarded.

A UPI generation rule set associated with the type of entity selected is retrieved, step 406. According to one embodiment of the invention, a UPI generation rule set comprises one or more rules for generating a UPI for a given entity. Additionally, the one or more UPI generation rules comprising a UPI generation rule set specify one or more attributes that must be associated with a given entity in order to generate a UPI according to the respective UPI generation rule. For example, a UPI generation rule set may be associated with a “router” entity. The UPI generation rule set may comprise one or more UPI generation rules for generating a UPI for a router. Additionally, the one or more UPI generation rules comprising the rule set may specify one or more attributes, such as a “serial number” attribute or a “MAC address attribute,” that must be associated with a given router in order to generate a UPI according to the one or more rules.

The one or more UPI generation rules comprising the rule set may be further associated with priority information indicating an ordering with which the one or more rules are to be selected, as well as timestamp information indicating the duration of time for which a UPI generated according to the one or more rules are to be considered valid. A first UPI generation rule is selected from the one or more UPI generation rules comprising the rule set associated with the selected entity, step 408. According to one embodiment of the invention, the first UPI generation rule selected comprises the UPI generation rule with the greatest associated priority or weight among the one or more rules comprising the selected rule set.

The attributes associated with the selected UPI generation rule are identified, step 410, and a check is performed to determine whether the selected entity satisfies the selected UPI generation rule, step 412. For example, a selected UPI generation rule may require an entity to be associated with a “serial number” attribute and a “device model number” attribute. The check at step 412 may determine whether the selected entity, such as a router, is associated with a “serial number” attribute and a “device model number” attribute.

Where the selected entity is not associated with the one or more attributes required by the selected rule, a check is performed to determine whether the selected rule comprises the last rule in the rule set, step 418. If the selected rule is not the last rule in the rule set associated with the selected entity, a next UPI generation rule is selected from the rule set, step 420. According to one embodiment of the invention, the next UPI generation rule selected comprises the UPI generation rule associated with the next greatest priority.

If the selected rule comprises the last rule in the UPI generation rule set, a UPI is not generated for the selected entity, step 422. The selected entity is considered to be not uniquely and persistently identifiable. For example, the selected entity may comprise a router associated with only an “IP address” attribute. If the “IP address” attribute associated with the selected entity did not satisfy the attribute requirements of the one or more rules comprising the rule set associated with the router, the router may be considered to be not uniquely and persistently identifiable.

If the selected entity is associated with the one or more attributes required by the selected rule, a UPI is generated using the rule selected, step 414. The UPI generated may indicate the rule with which the UPI was generated and the duration of time for which the generated UPI is to be considered valid, as indicated by the selected rule. Additionally, the UPI may be generated using one or more UPIs of the one or more entities with which the given entity is related, according to methods described herein.

The UPI generated for the selected entity is thereafter returned to the calling method with which the request to generate a UPI originated, step 416. For example, the UPI generated for the selected entity may be returned to a network modeling application or a network discovery application. The calling method may use the UPI associated with the selected entity for networking modeling, device inventory, etc.

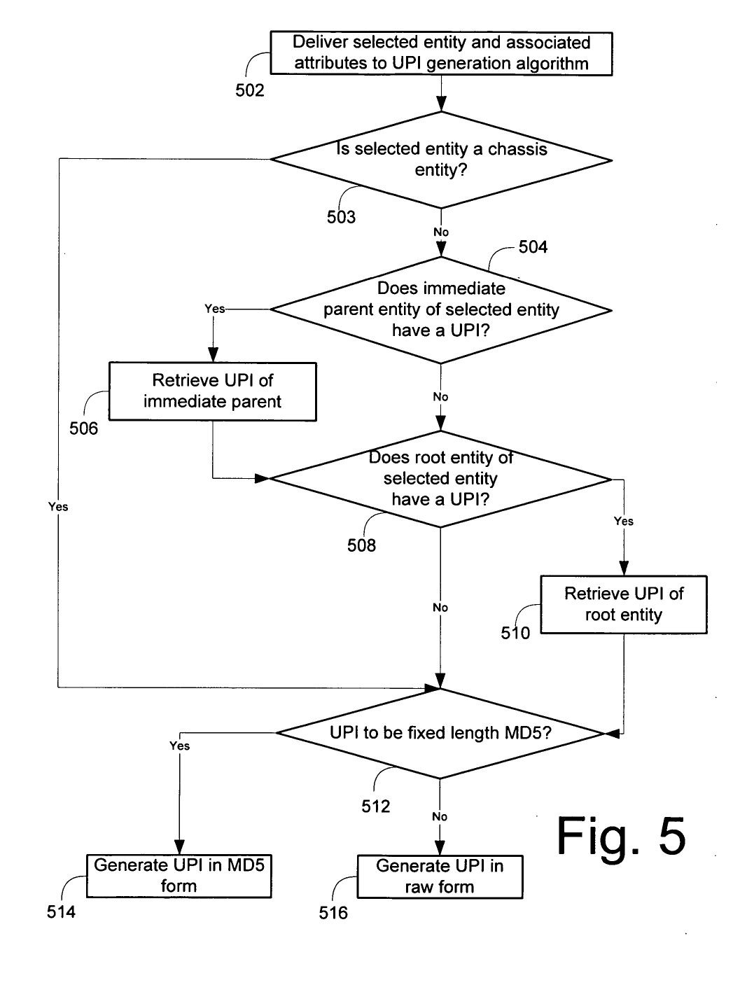

FIG. 5 is a flow diagram presenting a method for generating a unique and persistent identifier using one or more unique and persistent identifiers of the one or more entities with which a given entity is related, wherein a related entity may comprise an immediate parent entity or a root entity associated with a given non-chassis entity. According to the embodiment illustrated in FIG. 5, a selected entity and the one or more attributes associated with the selected entity are delivered to a UPI generation algorithm, step 502.

A check is performed to determine whether the selected entity comprises a chassis entity, step 503. If the selected entity does not comprise a chassis entity, a check is performed to determine whether the immediate parent of the selected entity is associated with a UPI, step 504. For example, if the selected entity comprises a port entity within a card entity, a check may be performed to determine whether a UPI has been generated for the card entity. If a UPI has been generated for the immediate parent of the selected entity, the UPI of the immediate parent entity is retrieved, step 506.

If a UPI has not been generated for the immediate parent of the selected entity, or after the UPI of the immediate parent entity is retrieved, a check is performed to determine whether a UPI has been generated for the root entity with which the selected entity is related, step 508. For example, if the selected entity comprises a port entity within a card entity, wherein the card entity is contained within a slot entity that is contained within a chassis entity, a check may be performed to determine whether a UPI has been generated for the chassis entity. If a UPI has been generated for the root entity with which the selected entity is associated, the root entity associated with the UPI is retrieved, step 510. Where the root entity is not associated with a UPI, or after the UPI of the root entity has been retrieved, a further check is performed to determine whether the UPI for the selected entity is to be generated in raw or Message-Digest algorithm 5 (“MD5”) form, step 512. If the check at step 512 evaluates to true, a UPI is generated for the selected entity in MD5 form, step 514. Where the check at step 512 evaluates to false, a UPI is generated in raw form, wherein raw form may comprise a human readable character string, step 516. Those of skill in the art recognize that a UPI may be generated in a variety of formats, and the format of a UPI is not limited to the embodiments illustrated in FIG. 5 and described herein.

The UPI generated for the selected entity may be generated using the UPIs of the immediate parent entity of the selected entity and/or the root entity associated with the selected entity. Using the UPIs associated with the immediate parent and/or the root entity of the selected entity increases the likelihood that the UPI generated for the selected entity is unique with respect to the one or more entities in a given network.

FIGS. 1-5 are conceptual illustrations allowing for an explanation of the present invention. It should be understood that various aspects of the embodiments of the present invention could be implemented in hardware, firmware, software, or a combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for generating unique and persistent identifiers for one or more entities within a network, the method comprising:
discovering one or more entities within a network, a given entity associated with one or more attributes and an entity type;
retrieving one or more unique and persistent identifier generation rule sets corresponding to the one or more entity types discovered within the network, a given rule set comprising one or more unique and persistent identifier generation rules; and
generating unique and persistent identifiers for the one or more discovered entities within the network through use of the unique and persistent identifier generation rule sets and the one or more attributes associated with the one or more entities.

2. The method of claim 1 wherein discovering one or more entities within a network comprises discovering one or more entities through use of a network discovery application.

3. The method of claim 1 wherein an entity comprises a hardware device.

4. The method of claim 1 wherein an entity comprises a constituent component of a hardware device.

5. The method of claim 1 wherein an entity comprises an application stored on a hardware device.

6. The method of claim 1 wherein an attribute comprises a serial number.

7. The method of claim 1 wherein an attribute comprises a Media Access Control address.

8. The method of claim 1 wherein an attribute comprises a sysObjectId.

9. The method of claim 1 wherein an attribute comprises a device model number.

10. The method of claim 1 wherein an attribute comprises a Domain Name Server name.

11. The method of claim 1 wherein an attribute comprises an Internet Protocol address.

12. The method of claim 1 wherein a unique and persistent identifier rule comprises a rule identifying one or more attributes with which an entity must be associated in order to generate a unique and persistent identifier according to the rule.

13. The method of claim 1 wherein generating unique and persistent identifiers comprises generating a unique and persistent identifier indicating the rule with which the unique and persistent identifier was created.

14. The method of claim 1 wherein a unique and persistent identifier rule comprises a rule identifying a period of time for which a unique and persistent identifier is considered to be valid when a unique and persistent identifier is generated according to the rule.

15. The method of claim 14 wherein generating unique and persistent identifiers comprises generating unique and persistent identifiers indicating the time period for which a unique and persistent identifier is considered to be valid.

16. The method of claim 1 comprising identifying one or more entities with which a given entity is related.

17. The method of claim 16 wherein a related entity comprises an immediate parent entity of a given entity.

18. The method of claim 16 wherein a related entity comprises a root entity with which a given entity is related.

19. The method of claim 16 wherein generating unique and persistent identifiers comprises generating unique and persistent identifiers using one or more unique and persistent identifiers associated with one or more entities with which a given entity is related.

20. The method of claim 1 wherein generating unique and persistent identifiers comprises generating unique and persistent identifiers in Message-Digest algorithm 5 (“MD5”) format.

21. The method of claim 1 wherein generating unique and persistent identifiers comprises generating unique and persistent identifiers in a human-readable format.

22. A system for generating unique and persistent identifiers for one or more entities within a network, the system comprising:
a discovery component operative to identify one or more entities within a network, a given entity associated with one or more attributes and an entity type;
a rule data store operative to store one or more rule sets comprising one or more rules for generating unique and persistent identifiers for the one or more entities in the network; and
a UPI component operative to:
retrieve a rule set comprising one or more rules corresponding to a given entity in the network; and
generate a unique and persistent identifier for the entity using the rule set retrieved and the one or more attributes associated with the entity.

23. The system of claim 22 wherein the discovery component is operative to identify one or more entities in a network through use of a network discovery application.

24. The system of claim 22 wherein the discovery component is operative to identify a serial number of a given entity.

25. The system of claim 22 wherein the discovery component is operative to identify a device model number of a given entity.

26. The system of claim 22 wherein the discovery component is operative to identify a sysObjectId of a given entity.

27. The system of claim 22 wherein the discovery component is operative to identify a Media Access Control (“MAC”) address of a given entity.

28. The system of claim 22 wherein the discovery component is operative to identify an Internet Protocol (“IP”) address of a given entity.

29. The system of claim 22 wherein the discovery component is operative to identify one or more entities with which a given entity is related.

30. The system of claim 22 wherein the rule data store is operative to store one or more rule sets comprising one or more rules identifying the one or more attributes with which a given entity must be associated in order to generate a unique and persistent identifier according to the one or more rules.

31. The system of claim 22 wherein the rule data store is operative to store one or more rule sets comprising one or more rules identifying a period of time for which one or more unique and persistent identifiers generated according to the one or more rules are to be considered valid.

32. The system of claim 22 wherein the rule data store is operative to store one or more rule sets corresponding to one or more entity types.

33. The system of claim 22 wherein the rule data store is operative to store one or more rule sets comprising one or more rules associated with priority information indicating an ordering with which the one or more rules are to be evaluated with respect to a given entity.

34. The system of claim 33 wherein the UPI component is operative to:
retrieve a rule set comprising one or more rules corresponding to a given entity in the network; and
generate a unique and persistent identifiers for the entity using the one or more rules according to the priority information associated with the one or more rules.

35. The system of claim 22 wherein the UPI component is operative to perform a validation check of the one or more attributes of a given entity.

36. The system of claim 22 wherein the UPI component is operative to generate a unique and persistent identifier for an entity indicating the rule with which the unique and persistent identifier was generated.

37. The system of claim 22 wherein the UPI component is operative to generate a unique and persistent identifier using one or more unique and persistent identifiers of the one or more entities with which a given entity is related.

38. The system of claim 37 wherein a related entity comprises an immediate parent entity of a given entity.

39. The system of claim 37 wherein a related entity comprises a root entity of a given entity.
